(19) United States
(12) Patent Application Publication
(10) Pub. No.: US 2026/0105158 A1
(43) Pub. Date: Apr. 16, 2026

(54) SYSTEMS AND METHODS FOR DETECTING AND MITIGATING SECURITY RISK IN SOFTWARE

(71) Applicant: SAP SE, Walldorf (DE)

(72) Inventors: Piergiorgio LADISA, Amsterdam (NL); Serena PONTA, Mouans Sartoux (FR); Antonino SABETTA, Mouans Sartoux (FR)

(21) Appl. No.: 18/915,991

(22) Filed: Oct. 15, 2024

(51) Int. Cl. G06F 21/57

(52) U.S. Cl. CPC G06F 21/577; G06F 2221/033

(57) ABSTRACT

Embodiments of the present disclosure include techniques for detecting and mitigating security risk in software. In one embodiment, library files are received and analyzed to extract information about the files. Software artifacts may be associated with categories, for example. Stored known information may be retrieved. Artifact statement rules may process the information about the files to generate new information. A risk score is generated based on the extracted, stored, and rule generated information about the files. In some embodiments, the library files are processed statically and dynamically.

### BACKGROUND

The present disclosure relates generally to computer software system security, and in particular, to systems and methods for detecting and mitigating security risk in software.

The increasing popularity of certain programming languages has spurred the creation of ecosystem-specific package repositories and package managers. Package repositories (e.g., npm, PyPI) serve as public databases that users can query to retrieve packages for various functionalities. On the other hand, package managers automatically handle dependency resolution and package installation on the client side. These mechanisms enhance software modularization and accelerate implementation. However, they have become a target for malicious actors seeking to propagate malware on a large scale.

From the attacker point of view, a 3rd party dependency may exploit functionalities provided by package managers to trigger execution of malicious code starting from the moment when the package is installed. This technique is profitable for the attacker as it provides high chances of success because developers often blindly trust the package manager and the latter often may not embed any security check to prevent dangerous executions.

Even when install time malicious behaviors are not exploited (e.g. because they are not available in certain programming language ecosystems), attackers may still hide malicious code in 3rd party dependencies and trigger the execution of such a code at runtime.

Therefore, detecting and mitigating security risks in software is a significant technical problem. The following disclosure provides various solutions to technical problems associated with software security.

### BRIEF DESCRIPTION OF THE DRAWINGS

FIG. 1 illustrates a system for detecting and mitigating security risk in software according to an embodiment.

FIG. 2 illustrates a method for detecting and mitigating security risk in software according to an embodiment.

FIG. 3 illustrates an example system for static and dynamic security scoring according to an embodiment.

FIG. 4 illustrates a method of static and dynamic security scoring according to another embodiment.

FIG. 5 illustrates hardware of a special purpose computing system configured according to the above disclosure.

### DETAILED DESCRIPTION

Described herein are techniques for detecting and mitigating security risk in software. In the following description, for purposes of explanation, numerous examples and specific details are set forth in order to provide a thorough understanding of some embodiments. Various embodiments as defined by the claims may include some or all of the features in these examples alone or in combination with other features described below and may further include modifications and equivalents of the features and concepts described herein.

In some embodiments, the present disclosure includes techniques for analyzing software files, such as library files, to determine if the files contain a security risk and to produce an assessment (e.g., a score) for such risk. Malicious code may be embedded in software, and detecting and determining risk associated with such code can be technically challenging, The present disclosure include solutions to the technical challenges associated with detecting and mitigating malicious code embedded in software.

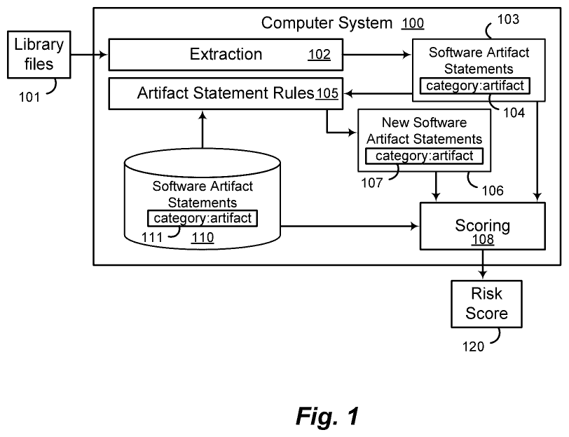

FIG. 1 illustrates a system for detecting and mitigating security risk in software according to an embodiment. Features and advantages of the present disclosure include software executing on a computer system 100. Computer system 100 may include, for example, one or more computers comprising one or more processors and memory for executing software to perform the techniques described herein. Here, software library files (or, library files) 101 may be analyzed to detect and mitigate security risks associated with incorporating the software library files in a software system. The software library files may support functionality that is to be used as part of a larger software system, for example. Software library files 101 may contain reusable code, functions, and routines that can be used by multiple programs. Software library files 101 may be linked to or included in other programs during a software build or runtime, for example. In some cases, software library files 101 are stored in repositories accessible over the Internet, and software developers may incorporate the software library files into their programs. However, since the repositories are often accessible by many users, the software library files stored therein may be targeted to include malicious code.

Computer system 100 may receive the software library files and execute an extraction software component 102. Extraction component 102 analyzes the software library files 101 and extracts software library artifact statements 103 from the software library files 101. In various embodiments, extracting software library artifact statements from library files 101 may be performed statically (e.g., analyzing the library files statically), during execution (e.g., executing the library files in a controlled/protected environment, or “sandbox,” to limit the impact of malicious code), or both, for example. Software library artifact statements 103 are sometimes referred to as “software artifact statements” or simply as “facts” (e.g., facts about the library file code). Accordingly, software library artifact statements 103 comprise information describing various aspects of the elements (e.g., code constructs) of the software library files. For example, a software library artifact statement may indicate that a particular file is an install script, that a particular file invokes a particular function, that a particular runtime process contains an invocation to a particular system call, that a particular memory contains a particular code construct (e.g., a URL), that certain code constructs may pose a security risk (i.e., are sensitive), or provide a wide range of other static or runtime information about software library files. Here, each software library artifact statement 103 comprises a category associated with one or more software library artifacts (aka, “artifacts”) as shown at 104. Software library artifacts are code constructs forming the executable software code, executable scripts, including filenames, function calls, runtime processes, system calls, memory indicators, code strings, etc. Herein, the term “function” refers to a wide range of software constructs, including functions, procedures, methods, and various forms of subroutines that implement software functionality, for example.

Further, in some embodiments, computer system 100 may include a repository 110 of stored software library artifact statements. The stored software library artifact statements in repository 110 may comprise known information about certain code constructs, which may include expert domain knowledge from programming experts and/or software security experts, for example. For instance, a stored software library artifact statement may indicate that a particular method belongs to a list of known security sensitive APIs that pose a security risk or that a particular method is an execution type API, for example. Similar to above, each software library artifact statement 110 comprises a category associated with one or more software library artifacts (aka, “artifacts”) as shown at 111. Accordingly, some portion of the software library artifact statements in repository 110 comprise a category indicating a software security risk. Example software library artifact statements 103 and 110 are illustrated below in a non-limiting example implementation.

Features and advantages of the present disclosure include combining the extracted artifact statements with the stored artifact statements to generate additional artifact statements useful in determining a software security risk. For example, the stored software library artifact statements may be retrieved from repository 110 and combined with the extracted artifact statements 101. Next, the extracted artifacts and stored artifacts retrieved from repository 110 are applied to artifact statement rules 105 (aka, a reasoner), which generates new software library artifact statements 106. Similar to the extracted and stored artifact statements, each new artifact statements 106 comprises a generated category associated with one of the extracted software library artifacts as illustrated at 107.

Embodiments of the present disclosure overcome the technical challenge of determining a security risk associated with potentially malicious code by using the extracted artifact statements 103, stored artifact statements from repository 110, and additional artifact statements 106 to produce a score corresponding to a security risk associated with one or more library files. Here, computer system 100 includes a scoring component 110 that receives extracted artifact statements 103, the artifact statements from repository 110, and the new artifact statements 106 and generates a risk score 120. Risk score 120 may be generated in a variety of ways using different formulas or custom-written policies to adjust risk scores based on certain one or more artifact statements (facts) or combinations thereof, either extracted or inferred from the rules. An example algorithm is provided below where artifact statements are mapped to values and the values are weighted to produce a risk score. In some embodiments, a machine learning algorithm may be trained to produce weights and/or values, for example, used to generate risk score 120. Risk score 120 may be presented on a user display or used by other software systems during further processing of the library files 101, for example. In some embodiments, a threshold value can be fine-tuned to automatically prevent the installation of a certain package or not if the risk value is too high (e.g., above the threshold).

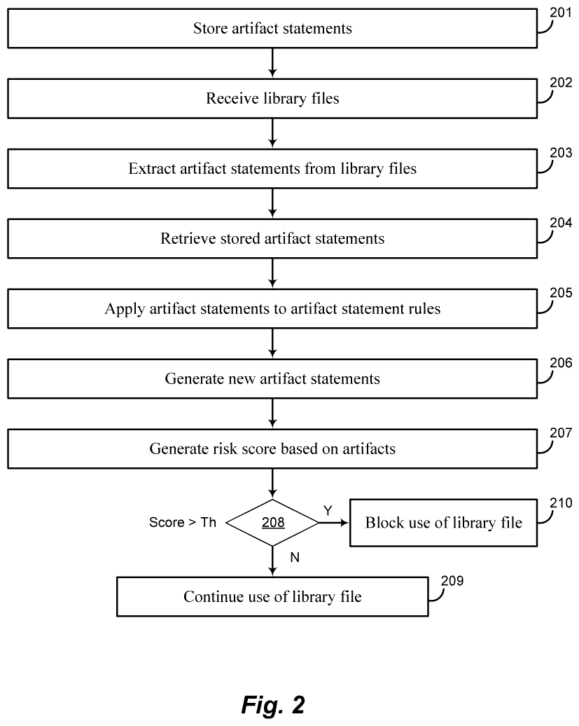

FIG. 2 illustrates a method for detecting and mitigating security risk in software according to an embodiment. At 201, artifact statements are stored in a repository. The artifact statements may comprise categories associated with software library artifacts. A portion of the stored artifact statements may comprise a category indicating a software security risk, for example. At 202, software library files are received by the system. At 203, artifact statements are extracted from the plurality of software library files. Similarly, the extracted artifact statements each comprising an extracted category associated with one or more extracted software library artifacts. At 204, stored artifact statements are retrieved. At 205, the extracted artifact statements and the stored artifact statements are provided as inputs to a plurality of artifact statement rules. As mentioned above, the artifact statement rules generate new artifact statements at 206, which similarly comprise a category (e.g., existing or new) associated with the software library artifacts extracted from one or more particular library files. At 207, a risk score is generated based on the extracted software library artifact statements, the stored software library artifact statements, and the new software library artifact statements. In this example embodiment, the risk score is compared to a threshold at 208. If the risk score is below the threshold (score>Th=N), then the system may continue processing and use the library file at 209. However, if the risk score is above the threshold (score>Th=Y), then the system may block use of the library file at 210, for example.

### EXAMPLE

Features and advantages of the present disclosure include a system to detect the presence of indicators of maliciousness in open-source software (OSS) packages prior to their usage (e.g., installation, availability for download). The present system first analyses the packages to extract software library artifact statements (aka, facts). In some embodiments, extraction may use an AI algorithm (e.g., trained to determine the presence of installation scripts performing an OS-level command to exfiltrate credentials). The extracted facts are then processed by rules (e.g., in a reasoner software component) to infer new facts. Next, a risk assessment module establishes the likelihood that the package might perform malicious operations based on the facts that were either extracted directly from the package or inferred through reasoning. Package managers or repositories can use the present system to prevent installation or publication of packages found to be malicious (e.g., after manual review of the analysis result). In some embodiment, the present techniques may detect indicators of maliciousness in 3rd party dependencies to mitigate the threats coming from use to prevent the execution of malicious code.

The example system may employ the principle to use both install-time (herein, static) and run-time (herein, dynamic) information. The example software extracts key information from an artifact project (i.e., a package of library files downloadable from repositories like npm, PyPI) and represents them in a compact and abstract model in the form of software library artifact statements (aka, facts). As an example, facts can be extracted with statically defined rules or using LLM with a suitable prompt. The facts are related to behaviors that can pose security risks for software that consumes such packages (e.g., the package uses install scripts that trigger execution at install-time, the package uses security-relevant APIs in the install scripts, etc.). Rules are applied to the facts extracted in the first stage and may use additional known facts available in a database to infer other facts that may be the evidence of a suspicious behavior that may pose security risks. The rules may be (but not limited to) configurable rules, machine learning, and so on. The system assesses the risks associated with the consumption of the analyzed package(s) based on the facts inferred from artifact statement rules (aka, fact reasoner). The risk score reflects the likelihood that the analyzed package is malicious (a report may additionally be produced to provide the reasons for the score).

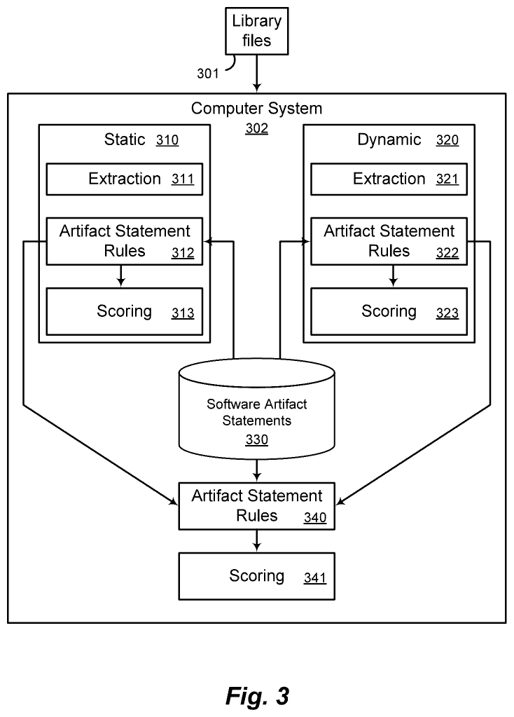

FIG. 3 illustrates an example system for static and dynamic security scoring according to an embodiment. In this example, library files 301 are received and processed by computer system 302 using a static software subsystem 310 and dynamic software subsystem 320. The system may then combine the static and dynamic components to produce a combined score, for example. Static subsystem 310 extracts facts using extraction component 311. Next, rule processing takes place in artifact statement rule component 312 (aka, reasoner) for all those elements that can be statically extracted from the package analysis. Additional known facts from repository 330 may also be used as inputs to the rules. A risk score can then be produced by the risk assessor scoring component 313 based on the facts inferred. Similarly, dynamic subsystem 320 extracts facts using extraction component 321, which may include execution of the package under scrutiny (e.g., in a protected sandbox environment). In this case, example facts that can be extracted are the presence of security-sensitive system calls, opening of connections, writing to file systems, reading of environment variables. A risk score can then be produced by the risk assessor 323 based on the facts inferred in the dynamic subsystem 320 using rules 322 and additional known facts from repository 330. In some embodiments, a rule unit 340 and risk assessor 341 combine the facts (e.g., including rule generated facts from 312 and 322) produced by the static and dynamic subsystems 310 and 320 to produce a risk factor. Each of the static and dynamic subsystems extract facts and produce their own risk score. In some embodiments, the totality of facts obtained in the reasoning phases of both the static and dynamic subsystems (plus known facts) can contribute to a final risk assessment by outputting new facts from 312 and 322 to rule component 340, which advantageously combines static risk analysis and dynamic risk analysis, for example. While static analysis may be faster than dynamic analysis, static analysis is limited because it does not cover possible malicious behaviors that are only visible at runtime. Indeed, malware can often obfuscate their content and thus evade static analysis, which can be detected using the present techniques.

In some embodiments, the static and dynamic subsystems may run in parallel, for example. In some embodiments, the parallel outputs of each may be combined with the aim to unveil as many malicious behaviors as possible. Alternatively, static and dynamic analysis can be configured to run only under particular circumstances. As an example, all subsystems in FIG. 3 can be run to obtain 3 risk scores that can be (optionally) combined to decide which package to manually review for malicious behavior. In other embodiments, dynamic analysis may run only if the risk score from static analysis is above a certain threshold, for example, to only check for packages having high risk for both subsystems in case performance is critical and false negatives may be accepted.

Extraction of software library artifact statements (aka, facts) may be performed as illustrated in the following examples. An extractor analyses the package and produces facts. In the following as example the prolog notation for facts is used. The fact extractor in the static subsystem 310 may produce facts such as those in the following examples. One example fact is “install_script(F)”, which indicates that a file F is an installation script (e.g., install_script(setup.py)) for a classical Python project. The fact associates a category (here, install_script) with a filename (here, F or setup.py). Another example fact is “invokes_static(F, A)”, which indicates that a file F invokes a function A (e.g., invokes_static (setup.py, exec)). This fact associates “invokes static” with software artifacts inside the parenthesis describing features of the library file (here, F and setup.py).

Similarly, the fact extractor in dynamic subsystem 320 may produce facts such as those in the following examples. One example fact is “invokes_dyn(P,C)”, which indicates that a runtime process P contains an invocation to a system call C, e.g., invokes_dyn(p, posix_spawn( )). As above, process P and system call C are artifacts associated with category “invokes_dyn” using this notation. Another example fact is “contains(M,S)”, which indicates that a RAM memory M contains a string S (e.g., that may be sensitive like a URL or a base64 encoded string).

As mentioned, the system may include a database 330 of known facts stored for use by the system to enhance the data available in generating a risk score. The known facts database may contain facts that are valid across multiple software systems and projects. For example, one fact in database 330 may be “is_sensitive(exec)”, which indicates that the “exec” method belongs to a list of known security sensitive APIs, which may pose security risks. Another example stored fact is “is_execution_api(exec)”, which indicates that the “exec” method is an API of execution type.

In some cases, artifact statement rules (aka, facts) may comprise functions. For example, “string_url_check(S):—<check whether a string is a url>” may check whether a string S is of the known type URL. It is to be understood that other similar checks can be made for other known types like IP address, base64 encoded, etc.

Artifact statement rules (aka, fact reasoner) produces additional facts based on (reasoning on) extracted facts and known facts, for example. As an example, the following inference rule produces a new fact stating that a file F contains a sensitive api A, based on the extracted fact that F invokes A and the known fact that A is sensitive: “invokes_sensitive(F,A):—invokes_static(F,A) & is_sensitive(A).” Accordingly, in some embodiments, artifact statement rules are logical rules configured to produce a new facts based on a logical combination (e.g., AND, OR, NOT) of extracted and/or stored facts. As another example, the following rule infers that the RAM memory contains a string of type URL: “contains_url(M,S):—contains(M,S) & string_url_check(S).” Finally, the following rule derives the knowledge that a file F performs a dangerous install time operation: “install_time_dangerous_execution(F):—install_script (F) & is_execution_api(exec) & invokes_static(F, exec).” In the case of a python application containing a setup.py file including the following lines:

```
from setuptools import setup
exec(“”import os; os.system(“echo ‘Hello World’”) “”)
setup(name=’foo’,
  version=’1.0’,
  py_modules=[‘foo’],
  )
```

The inference rules above would alert the system to the presence of a dangerous execution operation as follows: “install_time_dangerous_execution(setup.py):—install_script (setup.py) & is_execution_api(exec) & invokes_static(setup.py, exec).”

Example implementations of artifact statement rule components may include a reasoning engine (e.g. Prolog, RDF inference engines, etc), depending on how the facts and inference rules are expressed, for example.

The following is an example of how risk scores may be generated. A risk scoring component (aka, Risk Assessor) processes facts produced by the fact reasoner to compute a risk score metric. In the following example, the scoring function may be a weighted sum as follows:

$$Risk\_score = {\sum }_{i = N} {w}_{i} {x}_{i}$$

In this example, the extracted facts, stored facts retrieved from storage, and the generated new facts are mapped to a value (e.g., a risk value, where each value corresponds to a risk), a weight is associated with each value, the system calculates a sum of a product of each weight and each value. For instance, here, N is the total number of facts, xᵢ is the risk value associated to fact i, and wᵢ is the weight associated to the risk of the i-th fact. As mentioned above, weights can be statically defined or may be learned using AI or other machine learning algorithm, for example. In some example embodiments, each value is a binary value where nonzero values are weighted and summed. It is to be understood that other ways of determining an overall risk score are possible.

Once the risk score is computed, the user can take an informed decision about the potential danger associated with the consumption of a 3rd party dependency. The risk score(s) may be presented to the user, for example, with the list of facts that contributed to that risk. Furthermore, as mentioned above, a threshold value may be fine-tuned to automatically prevent the installation of a certain package or not if the risk value is too high.

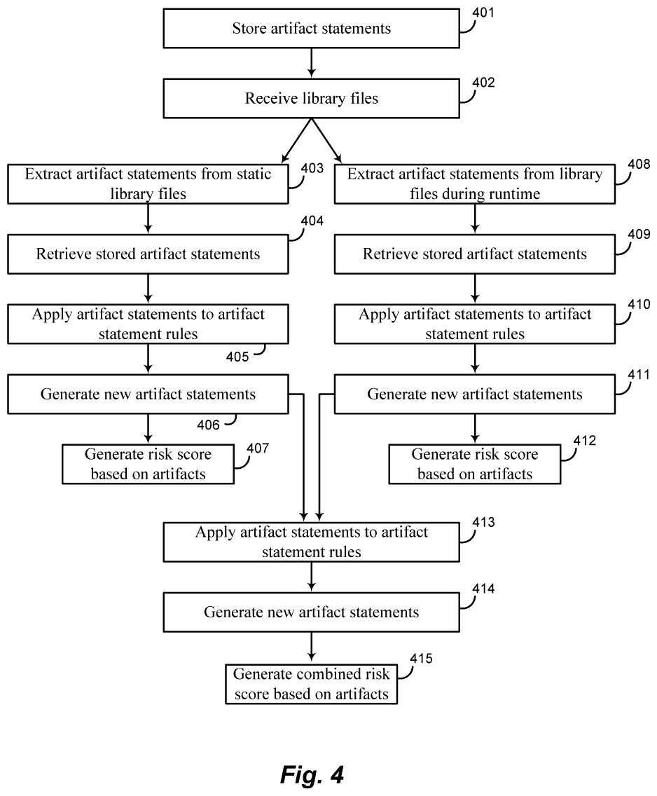

FIG. 4 illustrates a method of static and dynamic security scoring according to another embodiment. At 401, artifact statements are stored, which may include a category associated with software artifacts. At 402, the library files are received (e.g., as a package). At 403, static processing may begin by extracting artifact statements from the static library files (e.g., without execution). At 404, stored artifact statements are retrieved. At 405, the stored and extracted artifact statements applied to an artifact statement rules (reasoner) to produce new artifact statements at 406. At 407, a static risk score is generated based on the extracted, stored, and generated facts. At 408, dynamic processing may be by extracting artifact statements from the library files during execution (runtime). At 409, stored artifact statements are retrieved. At 410, the extracted and stored artifact statements are applied to artifact statement rule sets to produce new artifact statements at 411. At 412, a dynamic risk score is generated based on the extracted, stored, and generated facts. As mentioned above, in some embodiments, a third risk score may be generated. In some embodiments, the static and dynamic risk scores may be combined. In some embodiments, for example, facts extracted during static and dynamic analysis (403, 408), stored facts retrieved at 404/409, and new facts generated at 406/411 may be applied to rules at 413 to generate additional new facts at 414. The combined corpus of facts may be used to generate a combined risk score at 415. For example, all (or a portion) of the static and dynamic facts may be converted to risk values, multiplied by associated weights, and summed to produce a combined risk score.

In various embodiments, the techniques presented herein may used in a variety of application scenarios. For example, some or all of the techniques may be used to vet package repositories (e.g, npm, PyPI, internal mirrors) to prevent consumption of malicious components from downstream consumers. Additionally, software developers can use some of the techniques to assess the security risks in a software application, such as by scanning the entire dependency tree of their application. In some embodiments, the techniques above may be integrated in CI/CD pipline to conduct a threat model of the developed application. By conducting this analysis regularly, it is also possible to keep track of the evolution of the attack surface, depending on the increase or decrease of the computed risk score. In some embodiments, the techniques described herein can be integrated in package managers (e.g., npm, pip, mvn) such that before installing a 3rd-party dependency (and related transitive dependencies) the package manager may conduct a risk assessment. Then, the developer may be asked whether to continue or not with installation by providing to him a report on the possible risks associated with the 3rd-party dependencies.

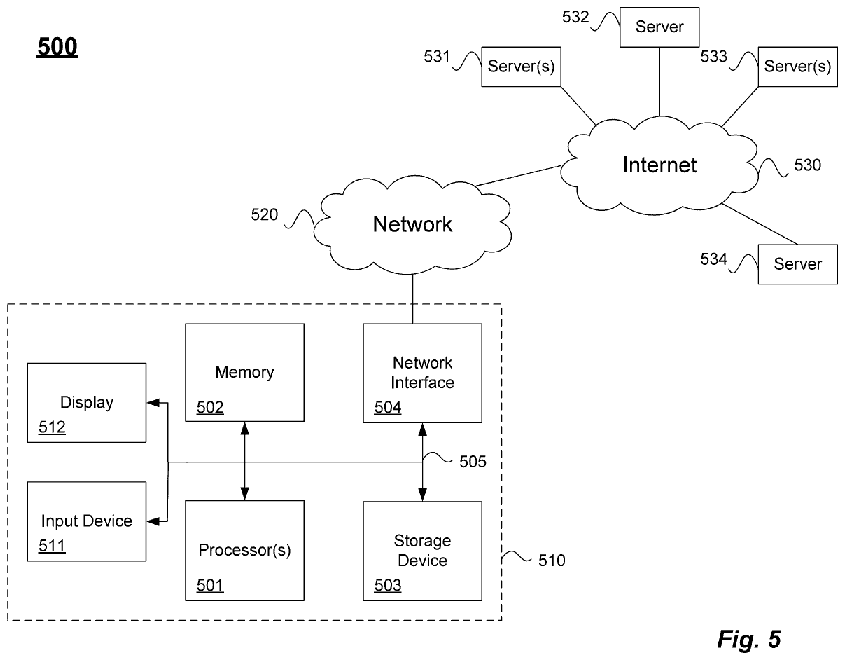

FIG. 5 illustrates hardware of a special purpose computing system 500 configured according to the above disclosure. The following hardware description is merely one example. It is to be understood that a variety of computers topologies may be used to implement the above-described techniques. An example computer system 510 is illustrated in FIG. 5. Computer system 510 includes a bus 505 or other communication mechanism for communicating information, and one or more processor(s) 501 coupled with bus 505 for processing information. Computer system 510 also includes memory 502 coupled to bus 505 for storing information and instructions to be executed by processor 501, including information and instructions for performing some of the techniques described above, for example. Memory 502 may also be used for storing programs executed by processor(s) 501. Possible implementations of memory 502 may be, but are not limited to, random access memory (RAM), read only memory (ROM), or both. A storage device 503 is also provided for storing information and instructions. Common forms of storage devices include, for example, a hard drive, a magnetic disk, an optical disk, a CD-ROM, a DVD, solid state disk, a flash or other non-volatile memory, a USB memory card, or any other electronic storage medium from which a computer can read. Storage device 503 may include source code, binary code, or software files for performing the techniques above, for example. Storage device 503 and memory 502 are both examples of non-transitory computer readable storage mediums (aka, storage media).

In some systems, computer system 510 may be coupled via bus 505 to a display 512 for displaying information to a computer user. An input device 511 such as a keyboard, touchscreen, and/or mouse is coupled to bus 505 for communicating information and command selections from the user to processor 501. The combination of these components allows the user to communicate with the system. In some systems, bus 505 represents multiple specialized buses for coupling various components of the computer together, for example.

Computer system 510 also includes a network interface 504 coupled with bus 505. Network interface 504 may provide two-way data communication between computer system 510 and a local network 520. Network 520 may represent one or multiple networking technologies, such as Ethernet, local wireless networks (e.g., WiFi), or cellular networks, for example. The network interface 504 may be a wireless or wired connection, for example. Computer system 510 can send and receive information through the network interface 504 across a wired or wireless local area network, an Intranet, or a cellular network to the Internet 530, for example. In some embodiments, a frontend (e.g., a browser), for example, may access data and features on backend software systems that may reside on multiple different hardware servers on-prem 531 or across the network 530 (e.g., an Extranet or the Internet) on servers 532-534. One or more of servers 532-534 may also reside in a cloud computing environment, for example.

### FURTHER EXAMPLES

Each of the following non-limiting features in the following examples may stand on its own or may be combined in various permutations or combinations with one or more of the other features in the examples below. In various embodiments, the present disclosure may be implemented as a system, method, or computer readable medium.

Embodiments of the present disclosure may include systems, methods, or computer readable media. In one embodiment, the present disclosure includes computer system comprising: at least one processor and at least one non-transitory computer readable medium (e.g., memory) storing computer executable instructions that, when executed by the at least one processor, cause the computer system to perform methods as described herein and in the following examples. In another embodiment, the present disclosure includes a non-transitory computer-readable medium storing computer-executable instructions that, when executed by at least one processor, perform the methods as described herein and in the following examples.

In one embodiment, the present disclosure includes a computer implemented method comprising: storing a first plurality of software library artifact statements, each software library artifact statement comprising a category associated with one or more software library artifacts, wherein a first portion of the first plurality of software library artifact statements comprise a category indicating a software security risk; receiving a plurality of software library files; extracting, from the plurality of software library files, a second plurality of software library artifact statements each comprising an extracted category associated with one or more extracted software library artifacts; retrieving the stored first plurality of software library artifact statements; applying the second plurality of software library artifact statements and the stored first plurality of software library artifact statements to a plurality of artifact statement rules, the artifact statement rules generating a third plurality of software library artifact statements each comprising a generated category associated with the extracted software library artifacts; and generating a first risk score based on the second plurality of software library artifact statements, the stored first plurality of software library artifact statements, and the third plurality of software library artifact statements.

In one embodiment, the extracted software library artifacts comprise one or more software executable filenames, function calls, or code strings.

In one embodiment, said extracting comprises extracting a first portion of the second plurality of software library artifact statements from at least a first portion of the plurality of software library files statically.

In one embodiment, said extracting comprises extracting a second portion of the second plurality of software library artifact statements from at least a second portion of the plurality of software library files during execution.

In one embodiment, the first risk score is based on a first portion of the second plurality of software library artifact statements, the method further comprising: generating a second risk score based on a second portion of the second plurality of software library artifact statements; and combining the first score and the second score to produce a composite risk.

In one embodiment, one or more of the plurality of artifact statement rules are logical rules configured to produce a new software library artifact statement based on a logical combination of one or more of the second plurality of software library artifact statements and one or more of the stored first plurality of software library artifact statements.

In one embodiment, a first artifact statement rule produces a corresponding first software library artifact statement of the third plurality of software library artifact statements indicating that a particular file of the plurality of software library files invokes a sensitive API.

In one embodiment, the first artifact statement rule comprises a logical AND of a second software library artifact statement of the second plurality of software library artifact statements indicating that the particular file invokes an API and a third software library artifact statement of the first plurality of software library artifact statements indicating that the API is sensitive.

In one embodiment, one or more of the plurality of artifact statement rules generate a new software library artifact statement indicating content of a memory.

In one embodiment, one or more of the plurality of artifact statement rules generate a new software library artifact statement indicating a dangerous runtime operation.

In one embodiment, generating the risk score comprises: mapping each of the second plurality of software library artifact statements, the stored first plurality of software library artifact statements, and the third plurality of software library artifact statements to a value; associating a weight with each value; and summing a product of each weight and each value.

In one embodiment, each value corresponds to a risk.

In one embodiment, each value is a binary value.

In one embodiment, generating each weight is generated using a machine learning algorithm.

The above description illustrates various embodiments along with examples of how aspects of some embodiments may be implemented. The above examples and embodiments should not be deemed to be the only embodiments, and are presented to illustrate the flexibility and advantages of some embodiments as defined by the following claims. Based on the above disclosure and the following claims, other arrangements, embodiments, implementations, and equivalents may be employed without departing from the scope hereof as defined by the claims.

What is claimed is:

1. A computer implemented method comprising:
storing a first plurality of software library artifact statements, each software library artifact statement comprising a category associated with one or more software library artifacts, wherein a first portion of the first plurality of software library artifact statements comprise a category indicating a software security risk;
receiving a plurality of software library files;
extracting, from the plurality of software library files, a second plurality of software library artifact statements each comprising an extracted category associated with one or more extracted software library artifacts;
retrieving the stored first plurality of software library artifact statements;
applying the second plurality of software library artifact statements and the stored first plurality of software library artifact statements to a plurality of artifact statement rules, the artifact statement rules generating a third plurality of software library artifact statements each comprising a generated category associated with the extracted software library artifacts; and
generating a first risk score based on the second plurality of software library artifact statements, the stored first plurality of software library artifact statements, and the third plurality of software library artifact statements.

2. The method of claim 1, wherein the extracted software library artifacts comprise one or more software executable filenames, function calls, or code strings.

3. The method of claim 1, wherein said extracting comprises extracting a first portion of the second plurality of software library artifact statements from at least a first portion of the plurality of software library files statically.

4. The method of claim 3, wherein said extracting comprises extracting a second portion of the second plurality of software library artifact statements from at least a second portion of the plurality of software library files during execution.

5. The method of claim 1, wherein one or more of the plurality of artifact statement rules are logical rules configured to produce a new software library artifact statement based on a logical combination of one or more of the second plurality of software library artifact statements and one or more of the stored first plurality of software library artifact statements.

6. The method of claim 5, wherein a first artifact statement rule produces a corresponding first software library artifact statement of the third plurality of software library artifact statements indicating that a particular file of the plurality of software library files invokes a sensitive API.

7. The method of claim 6, wherein the first artifact statement rule comprises a logical AND of a second software library artifact statement of the second plurality of software library artifact statements indicating that the particular file invokes an API and a third software library artifact statement of the first plurality of software library artifact statements indicating that the API is sensitive.

8. The method of claim 1, wherein one or more of the plurality of artifact statement rules generate a new software library artifact statement indicating content of a memory.

9. The method of claim 1, wherein one or more of the plurality of artifact statement rules generate a new software library artifact statement indicating a dangerous runtime operation.

10. The method of claim 1, wherein generating the risk score comprises:
mapping each of the second plurality of software library artifact statements, the stored first plurality of software library artifact statements, and the third plurality of software library artifact statements to a value;
associating a weight with each value; and
summing a product of each weight and each value.

11. The method of claim 10, wherein each value corresponds to a risk.

12. The method of claim 10, wherein each value is a binary value.

13. The method of claim 10, wherein generating each weight is generated using a machine learning algorithm.

14. A computer system comprising:
at least one processor;
at least one non-transitory computer-readable medium storing computer-executable instructions that, when executed by the at least one processor, cause the computer system to perform a method comprising:
storing a first plurality of software library artifact statements, each software library artifact statement comprising a category associated with one or more software library artifacts, wherein a first portion of the first plurality of software library artifact statements comprise a category indicating a software security risk;
receiving a plurality of software library files;
extracting, from the plurality of software library files, a second plurality of software library artifact statements each comprising an extracted category associated with one or more extracted software library artifacts;
retrieving the stored first plurality of software library artifact statements;
applying the second plurality of software library artifact statements and the stored first plurality of software library artifact statements to a plurality of artifact statement rules, the artifact statement rules generating a third plurality of software library artifact statements each comprising a generated category associated with the extracted software library artifacts; and
generating a first risk score based on the second plurality of software library artifact statements, the stored first plurality of software library artifact statements, and the third plurality of software library artifact statements.

15. The computer system of claim 14, wherein the executable software artifacts comprise one or more software executable files, software function calls, or strings.

16. The computer system of claim 14, wherein one or more of the plurality of artifact statement rules are logical rules configured to produce a new software library artifact statement based on a logical combination of one or more of the second plurality of software library artifact statements and one or more of the stored first plurality of software library artifact statements.

17. The computer system of claim 14, wherein one or more of the plurality of artifact statement rules generate a new software library artifact statement indicating content of a memory.

18. A non-transitory computer-readable medium storing computer-executable instructions that, when executed by at least one processor of a computer system, perform a method comprising:
storing a first plurality of software library artifact statements, each software library artifact statement comprising a category associated with one or more software library artifacts, wherein a first portion of the first plurality of software library artifact statements comprise a category indicating a software security risk;
receiving a plurality of software library files;
extracting, from the plurality of software library files, a second plurality of software library artifact statements each comprising an extracted category associated with one or more extracted software library artifacts;
retrieving the stored first plurality of software library artifact statements;
applying the second plurality of software library artifact statements and the stored first plurality of software library artifact statements to a plurality of artifact statement rules, the artifact statement rules generating a third plurality of software library artifact statements each comprising a generated category associated with the extracted software library artifacts; and
generating a first risk score based on the second plurality of software library artifact statements, the stored first plurality of software library artifact statements, and the third plurality of software library artifact statements.

19. The non-transitory computer-readable medium of claim 18, wherein the executable software artifacts comprise one or more software executable files, software function calls, or strings.

20. The non-transitory computer-readable medium of claim 18, wherein one or more of the plurality of artifact statement rules are logical rules configured to produce a new software library artifact statement based on a logical combination of one or more of the second plurality of software library artifact statements and one or more of the stored first plurality of software library artifact statements.
